(19) United States
(12) Patent Application Publication
(10) Pub. No.: US 2024/0185083 A1
(43) Pub. Date: Jun. 6, 2024

(54) LEARNING DIVERSE SKILLS FOR TASKS USING SEQUENTIAL LATENT VARIABLES FOR ENVIRONMENT DYNAMICS

(71) Applicant: DeepMind Technologies Limited, London (GB)

(72) Inventors: Steven Stenberg Hansen, London (GB); Guillaume Desjardins, London (GB)

(21) Appl. No.: 18/285,519

(22) PCT Filed: May 27, 2022
(86) PCT No.: PCT/EP2022/064491

§ 371 Date: Oct. 4, 2023

Related U.S. Application Data
(60) Provisional application No. 63/194,892, filed on May 28, 2021.

(51) Int. Cl. G06N 3/092

(52) U.S. Cl. CPC G06N 3/092

(57) ABSTRACT

This specification relates to methods for controlling agents to perform actions according to a goal (or option) comprising a sequence of local goals (or local options) and corresponding methods for training. As discussed herein, environment dynamics may be modelled sequentially by sampling latent variables, each latent variable relating to a local goal and being dependent on a previous latent variable. These latent variables are used to condition an action-selection policy neural network to select actions according to the local goal. This allows the agents to reach more diverse states than would be possible through a fixed latent variable or goal, thereby encouraging exploratory behavior. In addition, specific methods described herein model the sequence of latent variables through a simple linear and recurrent relationship that allows the system to be trained more efficiently. This avoids the need to learn a state-dependent higher level policy for selecting the latent variables which can be difficult to train in practice.

### CROSS-REFERENCE TO RELATED APPLICATIONS

This application claims the benefit of the filing date of U.S. Provisional Patent Application Ser. No. 63/194,892 for “LEARNING DIVERSE SKILLS FOR TASKS USING SEQUENTIAL LATENT VARIABLES FOR ENVIRONMENT DYNAMICS,” which was filed on May 28, 2021, and which is incorporated herein by reference in its entirety.

### BACKGROUND

This specification relates to reinforcement learning with neural network systems.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

The techniques described herein have applications in the field of reinforcement learning. In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

### SUMMARY

This specification relates to methods for controlling agents to perform actions according to a goal (or option) comprising a sequence of local goals (or local options) and corresponding methods for training.

According to a first aspect there is provided a computer-implemented method for controlling an agent while interacting with an environment, wherein the agent is controlled to execute a sequence of actions defining a state-action trajectory for achieving a goal. The goal may comprise (or may be characterized by) a sequence of local goals. Each local goal may be characterized by a corresponding latent variable. Each state-action trajectory may comprise a set of sub-trajectories and each sub-trajectory may be generated according to a corresponding local goal. The method may comprise, for each of a plurality of iterations, wherein each iteration corresponds to one of the sub-trajectories, determining the latent variable for the corresponding local goal using a predictor neural network configured to predict the latent variable in accordance with predictor parameter values based on a preceding latent variable. The method may further comprise, for each iteration, obtaining the corresponding sub-trajectory by, for each of a plurality of time steps: obtaining an observation characterizing a current state of the environment; processing the observation using the action selection policy neural network to generate a policy output; and selecting an action to be performed by the agent in response to the observation using the policy output. The action selection policy neural network may be conditioned on the latent variable and may generates the policy output in accordance with policy parameter values of the action selection policy neural network.

According to a second aspect there is provided a system comprising one or more computers and one or more storage devices storing instructions that when executed by the one or more computers cause the one or more computers to perform a method for controlling an agent while interacting with an environment, wherein the agent is controlled to execute a sequence of actions defining a state-action trajectory for achieving a goal. The goal may comprise (or may be characterized by) a sequence of local goals. Each local goal may be characterized by a corresponding latent variable. Each state-action trajectory may comprise a set of sub-trajectories and each sub-trajectory may be generated according to a corresponding local goal. The method may comprise, for each of a plurality of iterations, wherein each iteration corresponds to one of the sub-trajectories, determining the latent variable for the corresponding local goal using a predictor neural network configured to predict the latent variable in accordance with predictor parameter values based on a preceding latent variable. The method may further comprise, for each iteration, obtaining the corresponding sub-trajectory by, for each of a plurality of time steps: obtaining an observation characterizing a current state of the environment; processing the observation using the action selection policy neural network to generate a policy output; and selecting an action to be performed by the agent in response to the observation using the policy output. The action selection policy neural network may be conditioned on the latent variable and may generates the policy output in accordance with policy parameter values of the action selection policy neural network.

According to a third aspect there is provided one or more computer storage media storing instructions that when executed by one or more computers cause the one or more computers to perform a method for controlling an agent while interacting with an environment, wherein the agent is controlled to execute a sequence of actions defining a state-action trajectory for achieving a goal. The goal may comprise (or may be characterized by) a sequence of local goals. Each local goal may be characterized by a corresponding latent variable. Each state-action trajectory may comprise a set of sub-trajectories and each sub-trajectory may be generated according to a corresponding local goal. The method may comprise, for each of a plurality of iterations, wherein each iteration corresponds to one of the sub-trajectories, determining the latent variable for the corresponding local goal using a predictor neural network configured to predict the latent variable in accordance with predictor parameter values based on a preceding latent variable. The method may further comprise, for each iteration, obtaining the corresponding sub-trajectory by, for each of a plurality of time steps: obtaining an observation characterizing a current state of the environment; processing the observation using the action selection policy neural network to generate a policy output; and selecting an action to be performed by the agent in response to the observation using the policy output. The action selection policy neural network may be conditioned on the latent variable and may generates the policy output in accordance with policy parameter values of the action selection policy neural network.

According to a fourth aspect there is provided an agent configured to select actions to perform tasks in an environment, wherein the agent is controlled to execute a sequence of actions defining a state-action trajectory for achieving a goal, the goal comprising a sequence of local goals, each local goal being characterized by a corresponding latent variable, wherein each state-action trajectory comprises a set of sub-trajectories and each sub-trajectory is generated according to a corresponding local goal. The agent may comprise a predictor neural network, an action selection neural network and an agent control system. The predictor neural network may be parameterized by predictor parameter values and configured to determine, for each of a plurality of iterations, wherein each iteration corresponds to one of the sub-trajectories, a latent variable for the corresponding local goal based on a preceding latent variable. The action selection neural network may be configured to, for each of a plurality of time steps for each iteration, process an observation characterizing a current state of the environment to generate a policy output, wherein the action selection policy neural network is conditioned on the latent variable for the iteration and generates the policy output in accordance with policy parameter values of the action selection policy neural network. The agent control system may be configured to select an action to be performed by the agent in response to the observation using the policy output.

As discussed herein, environment dynamics may be modelled sequentially by sampling latent variables, each latent variable relating to a local goal and being dependent on a previous latent variable. These latent variables are used to condition an action-selection policy neural network to select actions according to the local goal. This allows the agents to reach more diverse states than would be possible through a fixed latent variable or goal, thereby encouraging exploratory behavior. In addition, specific methods described herein model the sequence of latent variables through a simple linear and recurrent relationship that allows the system to be trained more efficiently. This avoids the need to learn a state-dependent higher level policy for selecting the latent variables which can be difficult to train in practice.

In certain implementations, each latent variable is determined based on a previous latent variable. This introduces temporal dependence which allows the action selection policy neural network to reach more distant states. In addition, this allows local updates without sacrificing long term influence. Furthermore, certain implementations determine the previous latent variable using a predictor neural network that predicts the previous latent variable based on the previous sub-trajectory. For instance, the previous latent variable may be a latent variable that is most likely to have been selected based on a last (or final) observation in the previous trajectory. This applies hindsight correction to take into account the resulting sub-trajectories. This ensures that predicted latent variables are consistent according to the latent state dynamics.

In certain implementations, training methods are used to train the action selection neural network to select actions for exploratory behavior based on intrinsic rewards. An intrinsic reward can be a reward that is not received from the environment (e.g. that is not an extrinsic reward). This can be based on a distribution or information content of actions selected and/or states reached by the agent. For instance, an intrinsic reward may reward actions that increase the entropy of the states or actions and/or increase the mutual information between various parameters (such as between the latent variables and the states or actions). By training a system intrinsically, the system can learn effective behaviors (in this case, effective goals) before application to a specific task. An intrinsically trained system can therefore be more easily trained to perform a particular task based on extrinsic rewards.

The systems and methods described herein can therefore train the action selection neural network even in the absence of “task rewards,” e.g., extrinsic rewards that characterize a progress of an agent towards accomplishing a task in the environment.

For example, the method can initially train the action selection neural network using reinforcement learning techniques based on only intrinsic (unsupervised) rewards. After pre-training the action selection neural network using unsupervised rewards, the system can train the action selection neural network based on task rewards, or based on a combination of task rewards and unsupervised rewards.

The subject matter described in this specification can be implemented in particular embodiments so as to realize one or more of the following advantages. As discussed herein, environment dynamics may be modelled sequentially by sampling latent variables, each latent variable relating to a local goal and being dependent on a previous latent variable. These latent variables can be used to condition an action-selection policy neural network to select actions according to the local goal. This allows agents to reach more diverse states than would be possible through a fixed latent variable or goal, thereby encouraging exploratory behavior. In addition, specific methods described herein model the sequence of latent variables through a simple linear and recurrent relationship that allows the system to be trained more efficiently. This can avoid the need to learn a state-dependent higher level policy for selecting the latent variables, which can be difficult to train in practice.

In certain implementations, each latent variable is determined based on a previous latent variable. This introduces temporal dependence which allows the action selection policy neural network to reach more distant states. In addition, this allows local updates without sacrificing long term influence. Furthermore, certain implementations determine the previous latent variable using a predictor neural network that predicts the previous latent variable based on the previous sub-trajectory. For instance, the previous latent variable may be a latent variable that is most likely to have been selected based on a last (or final) observation in the previous sub-trajectory. This applies hindsight correction to take into account the resulting sub-trajectories. This ensures that predicted latent variables are consistent according to the latent state dynamics.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE FIGURES

FIG. 1 shows an example action selection system that is configured to control an agent interacting with an environment.

FIG. 2 shows graphical models for the determination of states with a single latent variable (top) and for a sequence of latent variables (bottom).

FIG. 3 shows a stochastic computation graph representing a process for implementing and training the latent predictor neural network and the action selection neural network.

FIG. 4 is a flow diagram showing a method of implementing (and optionally training) an action selection system (e.g. the action selection neural network 100 in FIG. 1).

FIG. 5 shows 2D latent codes shaded based on the ground truth x (left) and y (right) coordinates for an agent controlling a point-mass within an environment that includes a ‘U’ shaped wall.

FIG. 6 shows the estimated marginal code entropy H[zᵢ] (solid) and conditional entropy H[zᵢ|sᵢ₊₁] (dashed) for an implementation (EDDICT) and an alternative system (EDDICT-Δ).

### DETAILED DESCRIPTION

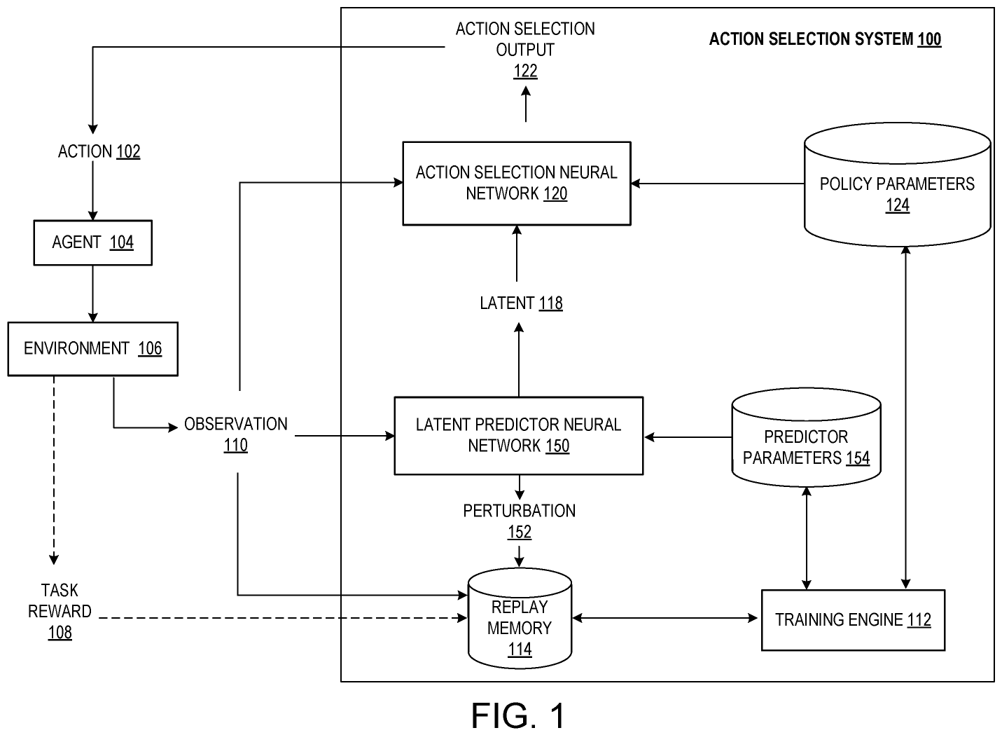

FIG. 1 shows an example action selection system 100 that is configured to control an agent 104 interacting with an environment 106. The action selection system 100 is an example of a system implemented as one or more computer programs on one or more computers in one or more locations in which the systems, components, and techniques described below are implemented.

The system 100 is configured to select actions 102 to be performed by the agent 104 to interact with the environment 106 over a sequence of time steps to accomplish a goal (or task). At each time step, the system 100 can receive data characterizing the current state of the environment 106 and select an action 102 to be performed by the agent 104 in response to the received data. Data characterizing a state of the environment 106 will be referred to in this specification as an observation 110 and can include, e.g., an image, or any other appropriate data. In some cases, the agent 104 can be, e.g., a robot, and the observation 110 can include, e.g., joint positions, velocities and torques, or any other appropriate data, as described in more detail below. At each time step, the state of the environment 106 at the time step (as characterized by the observation 110) depends on the state of the environment 106 at the previous time step and the action 102 performed by the agent 104 at the previous time step.

The system 100 is configured to select actions 102 to be performed by the agent 104 to interact with the environment 106 over a sequence of time steps using an action selection neural network 120 (otherwise known as an “action selection policy neural network”) conditioned on a latent variable 118. The system 100 is configured to determine the latent variable 118 from a set of possible latent variables using a latent predictor neural network 150. The latent predictor neural network 150 may be conditioned on one or more previous observations (e.g. a final observation in a sub-trajectory, as discussed below). The latent variable 118 may be determined by predicting a preceding latent variable based on the one or more previous observations and adding a perturbation 152 to the predicted previous latent variable.

Any parameters input into the latent predictor neural network 150 (e.g. the one or more previous observations and the perturbation 152) may be stored in replay memory 114 for use in training. In one implementation, the perturbation 152 and the final observation from the most recent sub-trajectory may be stored in replay memory 114 to allow the latent variable to be recalculated during training (e.g. using the most up to date version of the latent predictor neural network 150). Further details of the determination of the latent variable 118 are provided below.

The system 100 can then use the action selection neural network 120, conditioned on the latent variable 118, to select actions 102 to be performed by the agent 104 over a sequence of time steps. Generally, “conditioning” the action selection neural network 120 on the latent variable 118 can refer to providing the latent variable 118 to the action selection neural network 120 as an input. In some implementations, the set of possible latent variables can include only finitely many possible latent variables, e.g., 10, 100, 1000, 10,000, or any other appropriate number of latent variables. In some implementations, the set of possible latent variables can include infinitely many possible latent variables, e.g., the set of possible latent variables can be the continuous range [0, 1].

Each latent variable can represent a “skill,” e.g., a set of actions that characterize a behavior of the agent 104 over a sequence of time steps. That is, each latent variable can prompt the agent 104 to interact with the environment 106 in a manner that causes the state of the environment 106 to be altered over a sequence of time steps in a consistent and recognizable way. In other words, a “skill” can refer to an action selection policy defined by conditioning the action selection neural network 120 on the latent variable 118. For example, a skill can refer to an action selection policy π_{θ}(a|s, z) that maps from states s and latent variables z to distributions over actions α, where θ is a set of policy parameters 124 of the action selection neural network 120. As described in more detail below, by training the action selection neural network 120 on unsupervised rewards, the system 100 can enable the action selection neural network 120 to learn distinct and recognizable skills.

In certain implementations, each latent variable is determined by inputting one or more preceding observations 110 into the latent predictor neural network 150. The latent predictor neural network may attempt to predict the previous latent variable based on the one or more preceding observations 110. A new latent variable 118 may then be determined based on the predicted previous latent variable. This may be determined through a linear auto-regressive process. For instance, this may be determined by adding a perturbation (e.g. a linear perturbation) to the predicted previous latent variable.

By implementing sequences of latent variables (latent codes) the system is able to reach states much further in the time horizon than previous methods. By utilising a linear autoregressive methodology, the system is able to efficiently implement these sequences of latent codes without having to learn a high-level parametric policy over the latent variables, which can be difficult and which has been shown to lead to fewer learned codes/goal states. Furthermore, hard coding the dynamics to be linear naturally imposes an interpretable Euclidian topology in latent space.

As a particular example, if the agent 104 is a physical robot exploring the environment, a first latent variable can define a first set of possible actions for the robot (e.g. that include the actions of moving forward, backward, to the left, and to the right) for exploring a certain region of the environment. A second latent variable can define a second set of possible actions of the robot for exploring a different region of the environment. In this case, the first latent variable and the second latent variable can each represent a distinct and recognizable skill of the robot, characterizing different forms of behavior. By implementing a sequence of latent variables (latent codes), the robot can explore further within the environment, reaching sections of the environment that may have previously been unobtainable using only a single set of behaviors.

After conditioning the action selection neural network 120 on the latent variable 118, the system 100 can use the action selection neural network 120 to select actions 102 to be performed by the agent 104 to interact with the environment 106 over a sequence of time steps. For example, at each time step, the system 100 can process the observation 110 characterizing the current state of the environment 106 at the time step, and the latent variable 118, using the action selection neural network 120, to generate an action selection output 122. In some implementations, in addition to processing the observation 110 characterizing the current state of the environment 106 at the time step, the system 100 can also process one or more observations that each characterize the state of the environment at a respective previous time step.

The action selection output 122 can include a respective score for each action in a set of possible actions that can be performed by the agent 104. In some implementations, the system 100 can select the action having the highest score, according to the action selection output 122, as the action to be performed by the agent 104 at the time step. In some implementations, the system 100 selects the action 102 to be performed by the agent 104 in accordance with an exploration strategy. For example, the system 100 can use an ϵ-greedy exploration strategy. In this example, the system 100 can select the action having a highest score (according to the action selection output 122) with probability 1−ϵ, and select an action randomly with probability ϵ, where ϵ is a number between 0 and 1.

A trajectory may be accumulated by implementing a series of actions. A trajectory τ=[s₀, a₀, s₁, a₁, . . . sₜ, aₜ, s_{T}] may include a series of observations characterizing states sₜ and actions aₜ over a series of T time steps t. An overall trajectory τ may comprise a series of sub-trajectories τᵢ. Each sub-trajectory may be of length K, τᵢ=[a_{iK}, s_{iK+1}, a_{iK+1}, . . . , a_{(i+1)K-1}, s_{(i+1)K}]. Note that the sub-trajectory here is defined to include s_{(i+1)K} but not the state s_{iK} from which a_{iK} was sampled.

Each sub-trajectory τᵢ may be determined be conditioning the action selection neural network 120 using a corresponding latent variable 118. Each latent variable may be determined based on a previous sub-trajectory τᵢ. A series of latent variables may therefore be determined which condition the action selection neural network 120 to adapt its behavior over time.

Accordingly, in certain implementations, an action selection neural network 120 is trained to select actions based on a goal (otherwise known as an option or skill) characterized by a sequence of local goals (e.g. local options or local skills). Each local goal may be considered to define a learned behavior of the agent. This allows the action selection neural network 120 to be conditioned to select actions according to the local goal to form a sub-trajectory. The sequence of local goals may form an overall goal. The sequence of sub-trajectories may form an overall trajectory.

For each iteration, a sub-trajectory may be obtained including, for each time step, an observation and an action. This may be obtained by, over the multiple time-steps, selecting an action, instructing the agent to perform the selected action, and receiving an updated observation characterizing an updated state of the environment after the performance of the action.

After the system 100 selects the action 102 to be performed by the agent 104 at the time step, the agent 104 interacts with the environment 106 by performing that action 102, and the system 100 can receive a reward based on the interaction, e.g., a task reward 108, an unsupervised reward, or both. The training engine 112 may be configured to determine the unsupervised reward either immediately after the interaction, or after a number of actions have been performed (e.g. after a batch of actions have been implemented, e.g. to form a sub-trajectory, which may be stored in the replay memory 114). The task reward 108 is optional, as the system 100 may train the action selection neural network 120 and/or the latent predictor neural network 150 based solely on unsupervised training (e.g. unsupervised rewards). When training the latent predictor neural network 150, predictor parameters 152 for the latent predictor neural network 150 may be updated. Similarly, then training the action selection neural network 120, policy parameters 124 for the action selection neural network 120 may be updated.

As mentioned above, the implementations described herein implement a sequence of latent variables zᵢ to condition an action selection neural network to adapt its behavior over time to reach a wider variety of states.

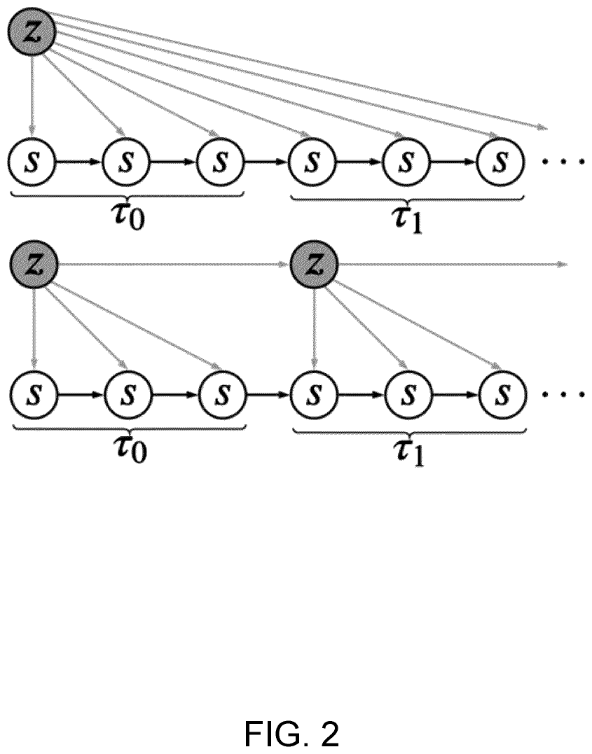

FIG. 2 shows graphical models for the determination of states with a single latent variable (top) and for a sequence of latent variable (bottom). Where a single latent variable is utilized, this single latent variable z is used to condition the action selection neural network, which results in a trajectory τ, formed of sub-trajectories τᵢ. Each sub-trajectory τ is determined using the same latent variable z. In contrast, in implementations described herein, the latent variable z is updated over time, and a new latent variable z is used to determine each sub-trajectory τ. Each subsequent latent variable z is determined from the previous (the immediately preceding) latent variable z (e.g. a latent variable for the iteration immediately preceding the current iteration).

That is, the determination of the (current) latent variable z may be an autoregressive process. In other words, each latent variable may be dependent on the immediately preceding latent variable in the sequence. In one implementation the determination of the latent variable may be an autoregressive process of order one (e.g. an AR(1) process), such that only the previous latent variable from the sequence of latent variables is used to infer the current latent variable (although one or more perturbations and/or constants may be added). The latent variables z over the iterations may form a Markov chain. That is, the sequence of latent variables z corresponding to the sequence of local goals may form a Markov chain.

Specifically, the determination of each latent code may be a linear autoregressive process. This provides linear dynamics across the sequence of latent variables. This makes the system easier and more computationally efficient to train. A further advantage of ensuring linear dynamics, versus learning a parametric policy over latent variables, is that it naturally imposes an interpretable Euclidian topology in latent variable space. This can provide meaningful latent state representations (e.g. that are descriptive of the environment being explored).

Having said the above, if each latent variable zᵢ is based on the preceding latent variable zᵢ₋₁ that was actually used (rather than a predicted version), then the generation of the latent variables ignores the underlying states in which the code is sampled. This can make training the system brittle in practice. Accordingly, when sampling the latent variables zᵢ˜p(zᵢ|zᵢ₋₁), some implementations condition on the code most likely to have yielded the final state of the preceding trajectory. This code (latent variable) may be determined using the latent predictor neural network 150. The use of the latent predictor neural network 150 (otherwise known as a reverse predictor) adds hindsight correction to the methodology. Importantly, as shall be discussed below, this objective induces a cross-entropy term between the target distribution q_{w}(zᵢ₋₁|sᵢ)p(zᵢ|zᵢ₋₁) and q_{w}(zᵢ|sᵢ₊₁). This ensures that predictions made from sᵢ₊₁ are consistent with those from sᵢ, under the current latent state dynamics.

According to one implementation, each latent variable is determined by predicting the previous latent variable \tilde{z}ᵢ₋₁ from the preceding sub-trajectory τᵢ₋₁ using the latent predictor neural network 150 and adding a perturbation Δᵢ to the predicted (inferred) previous latent variable \tilde{z}ᵢ₋₁ to generate the latent variable zᵢ:

zᵢ=\tilde{z}ᵢ₋₁+Δi

Specifically, the latent predictor neural network 150 may be configured to predict the latent variable based on the final state s_{iK} that is reached in the preceding sub-trajectory (note that in the present definition of a sub-trajectory, τᵢ₋₁ includes s_{iK} as the final state):

zᵢ=ƒ_{w}(s_{iK})+Δᵢ

where ƒ_{w}(t) represents a parametric function according to the latent code predictor neural network 150 parameterized by predictor parameters w.

The perturbation Δᵢ may be determined from a perturbation distribution. The perturbation distribution may be one of a uniform distribution (e.g. a uniform distribution on the disc) or a Gaussian distribution. A uniform distribution may be used where the action space is discrete. A Gaussian may be used where the action space is continuous. The Gaussian may be an isotropic Gaussian. The Gaussian may be a truncated Gaussian.

Given the above, the code predictor may be q_{w}(z|s):= [symbol] (ƒ_{w}(s), 1).

The perturbation may be a noise signal that encourages exploration. By adding a perturbation at each iteration, the method can ensure that the marginal latent variable entropy increases monotonically with each sub-trajectory (e.g. more states being visited) while the conditional entropy remains constant (e.g. the same number of states being reachable from any given state).

In an implementation, the method is initialized in a first iteration by determining a first latent variable \tilde{z}₀ based on a first observation characterizing a first state s₀ of the environment. The first latent variable \tilde{z}₀ may be predicted through inputting the first state s₀ into the latent predictor neural network. A permutation may be added to this first latent variable \tilde{z}₀. Following this, a first sub-trajectory may be obtained through implementing the action selection policy neural network when conditioned on the first latent variable. Following this, subsequent iterations may be based on the preceding latent variable.

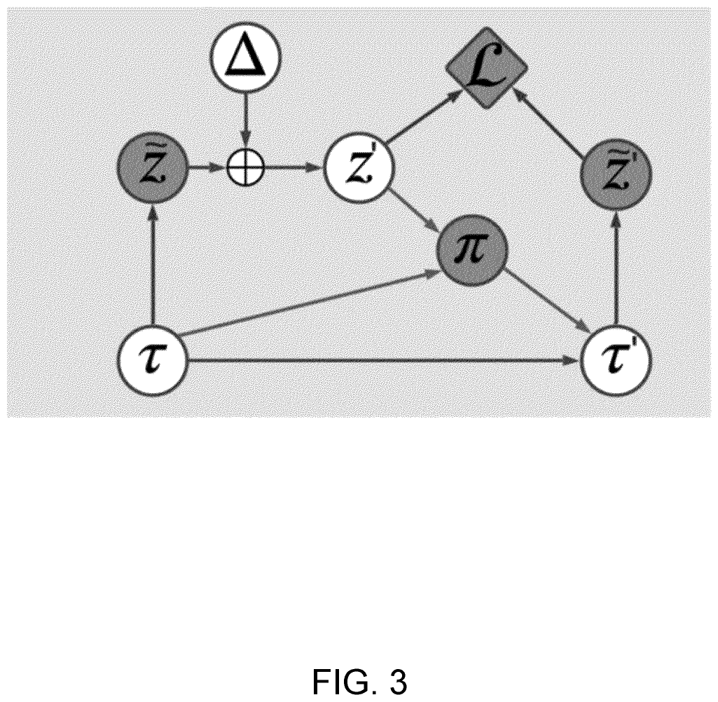

FIG. 3 shows a stochastic computation graph representing a process for implementing and training the latent predictor neural network and the action selection neural network.

As discussed herein, the most recent sub-trajectory τ is input into the latent predictor neural network to predict the most recent latent variable \tilde{z}. This is added to a perturbation Δ, which may be sampled from a perturbation distribution (e.g. a Gaussian or uniform distribution) to determine an updated latent variable z′. The updated latent variable z′ and the most recent sub-trajectory τ are then input into the action selection neural network (represented in FIG. 3 by π) to determine the next sub-trajectory τ′. The new sub-trajectory is used to determine a prediction of the most recent latent variable \tilde{z}′ (note, this the most recent latent variable is now z′). The ground truth latent variable z′, and the predicted latent variable \tilde{z}′ are then used to train the latent predictor neural network using a loss function [symbol] . It should be noted that, in addition to training the latent predictor neural network, the action selection neural network may be trained based on the observed states and actions within the sub-trajectories.

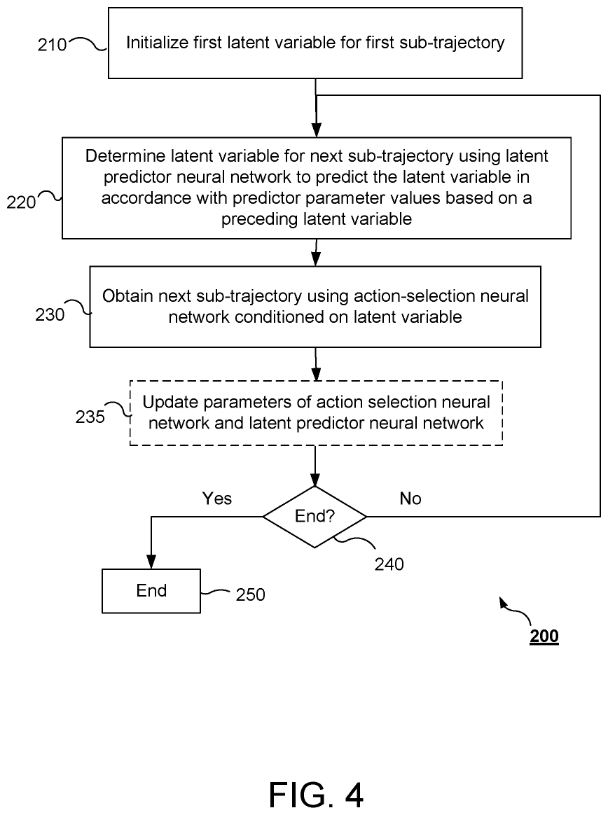

FIG. 4 is a flow diagram showing a method of implementing (and optionally training) an action selection system (e.g. the action selection neural network 100 in FIG. 1). The process 200 may be performed by a system of one or more computers located in one or more locations. For example, an action selection system, e.g., the action selection system 100 in FIG. 1, appropriately programmed in accordance with this specification, can perform the process 200.

The method starts by initializing the first latent variable for a first sub-trajectory 210. As described above, this may be determined by inputting a first observation representing a first state of the environment into a latent predictor neural network and adding a perturbation. The method then repeats steps 220, 230, (optionally) 235 and 240 for a number of iterations.

In step 220, the preceding latent variable (the latent variable from the preceding iteration) is used to determine the latent variable for the next sub-trajectory (the latent variable for the current iteration). This is achieved using the latent predictor neural network in accordance with predictor parameter values. The conditioning on the preceding latent variable may include hindsight correction. In this case, instead of inputting the ground truth preceding latent variable, a prediction of the preceding latent variable is determined by inputting at least a portion of the preceding sub-trajectory (e.g. the last observation) into the latent predictor neural network and adding a perturbation.

In step 230, the next sub-trajectory (the sub-trajectory for the current iteration) is determined using the action-selection neural network conditioned on the (current) latent variable. This may be achieved over a number of time steps. In each time step, the system may: obtain an observation characterizing a current state of the environment; process the observation using the action selection policy neural network to generate a policy output, wherein the action selection policy neural network is conditioned on the latent variable and generates the policy output in accordance with policy parameter values of the action selection policy neural network; and select an action to be performed by the agent in response to the observation using the policy output. The action may be selected using a ϵ-greedy policy (e.g. where a greedy policy (e.g. that selects an action with the maximum expected return) is implemented with a probability of 1−ϵ and a random action is selected with a probability of ϵ).

In step 235, the parameters of the action selection neural network (policy parameter values) and the parameters of the latent predictor neural network (the predictor parameter values) may, optionally, be updated. This comprises updating one or both of the policy parameter values and the predictor parameter values based at least on one or more of the sub-trajectories. That is, one or both of the action selection policy neural network and the predictor neural network may be trained over one or more of the iterations.

Step 235 is optional, in that it is not be implemented when a trained system is operating, but may be implemented when training the system. The update step 235 may be implemented during each iteration, or may be implemented during a selection of the iterations (e.g. after a number of iterations).

An augmented trajectory may be formed, including a starting observation of a starting state of the environment, each sub-trajectory and each latent variable (or parameters for recalculating each latent variable, such as the perturbations). Training may be performed based on the augmented trajectory. The update step 235 will be described in more detail below.

After each iteration, the method determines whether an end criterion is reached 240 (e.g. a maximum number of iterations have been implemented, or an evaluation or validation criterion has been met). If so, then the method ends 250. If not, then the method implemented another iteration (steps 220, 230, optionally 235, and 240).

The training of the system will now be described. The update step 235 may include an optimization step that updates the parameters of the action selection neural network according to an objective to maximize the entropy of the policy (as defined by the policy parameters). This can be determined through greedy optimization. The maximization of the entropy may be a maximization of effective entropy. That is, one or both of the policy parameter values and the predictor parameter values may be updated based on an objective that aims to maximize the effective entropy.

The effective entropy (H_{effective}) may be the difference in log probabilities given by the predictor neural network and the probability of each latent variable given the previous latent variable. In other words, the effective entropy may be defined as the difference in log-probabilities given the latent predictor neural network and the high-level policy over options. The effective entropy may be:

H_{effective}=log q_{w}(zᵢ|τᵢ)−log p(zᵢ|zᵢ₋₁)

where q_{w}(zᵢ|τᵢ) describes a probability of the latent variable τᵢ given the sub-trajectory τᵢ for an i^{th} iteration, and p(zᵢ|zᵢ₋₁) is the probability of a latent variable zᵢ given a previous latent variable zᵢ₋₁ for the (i−1)^{th} iteration. As described above, p(zᵢ|zᵢ₋₁) may be determined from a previous sub-trajectory τᵢ₋₁. In addition, as described above, the conditioning on τᵢ or τᵢ₋₁ may be based on the final state reached by the respective sub-trajectory.

The first half of the above equation relates is used to train the action selection neural network, whereas the second half is used to train the latent predictor neural network. The first half of the effective entropy equation may define relate to a first objective that aims to maximize the entropy of the policy. The first half of the above equation may be maximized through reinforcement learning. An intrinsic reward r may be provided at the end of a given sub-trajectory. This reward may be:

r∝log q_{w}(zᵢ|τᵢ)

According to one implementation, the reward is based on the last state sᵢ₊₁ that is achieved in the sub-trajectory τᵢ:

r∝log q_{w}(zᵢ|τᵢ)

where q_{w} is a probability distribution describing a probability of zᵢ given s_{T,i} according to the predictor parameter values w. For all time steps before the final time step within the sub-trajectory, the reward may be set to zero.

The rewards may be recorded in the augmented trajectory, and the action selection neural network may be updated using any reinforcement learning algorithm based on the augmented trajectory. This may be based on either the most recent sub-trajectory and rewards, or based on a number (e.g. all) previous sub-trajectories and rewards. Reinforcement learning may be implemented through an ϵ-greedy approach. According to an implementation, both the policy parameter values and the predictor parameters values are updated using reinforcement learning based on rᵢ.

When updating the predictor parameter values, the update may be based on updating the predictor parameter values based on a second objective that aims to minimize a cross-entropy between consecutive latent variables. This may be the second part of the above effective entropy equation: −log p(zᵢ|zᵢ₋₁). This term results in an update that attempts to minimize a difference between consecutive latent variables.

As described above, hindsight correction may be applied to predict the previous latent variable and then the next latent variable may be determined by adding a perturbation (e.g. as sampled from a Gaussian distribution) to the predicted previous latent variable. In this case, the probability distribution p_{w} describing a probability of a latent variable z given an observation s according to predictor parameter values w may be p_{w}(z|s)= [symbol] (ƒ_{w}(s), 1) for a function ƒ_{w}(s), e.g. where ƒ_{w}(s) is defined by parameter values w (i.e. ƒ_{w}(s) is modelled by the latent predictor neural network). In this case, the update aims to minimize:

∥Δᵢ−(ƒ_{w}(s_{(i+k)L})−ƒ_{w}(s_{iK})∥₂²

where
s_{(i+1)K} is a last observation of K observations for the i^{th} iteration;
S_{iK} is a last observation of K observations for the (i−1)^{th} iteration; and
Δᵢ is a perturbation added an output from the predictor parameter neural network at the i^{th} iteration to determine the i^{th} latent variable zᵢ. In the above, ƒ_{w}(s) may represent an output of the predictor neural network based on observation s.
   The above minimization be implemented through gradient descent based on

∥Δᵢ−(ƒ_{w}(s_{(i+1)K})−ƒ_{w}(s_{iK}))∥₂²

The above loss is intuitive: the reverse predictor is trained such that the inferred latent state from sᵢ, matches the inferred state from sᵢ₊₁ under the present latent dynamics (i.e. to minimize the difference between the inferred latent state from sᵢ and the inferred latent state from sᵢ₊₁). It has been found that an uninformative prior performed best in practice (despite the choice of isotropic Gaussian for the predictor), and thus in one implementation Δᵢ is sampled from a uniform distribution on the disc.

In addition to training based on an intrinsic objective (e.g. based on intrinsic rewards), the method may also train using extrinsic rewards received from the environment. This may occur after a number of iterations of intrinsic training (i.e. without extrinsic rewards). The extrinsic training may be implemented in conjunction with intrinsic training, or based solely on the extrinsic rewards. In either case, the method of FIG. 4 may be implemented, where step 235 includes updating the parameters of one or both of the predictor neural network and the action selection policy neural network based at least partially on extrinsic rewards (one or more rewards received from the environment in response to one or more selected actions). For instance, an extrinsic reward may be received for each selected action (during step 230). The update 235 may then be based on the extrinsic rewards and, optionally, on the intrinsic rewards. For instance, the extrinsic reward for each time step may be added to the intrinsic reward for each time step (potentially with a scaling factor applied to one of the intrinsic and extrinsic rewards).

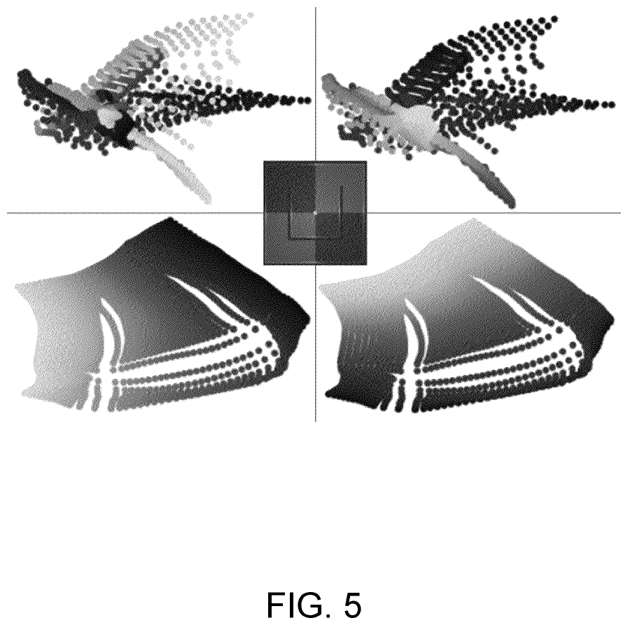

FIG. 5 shows 2D latent codes shaded based on the ground truth x (left) and y (right) coordinates for an agent controlling a point-mass within an environment that includes a ‘U’ shaped wall. The environment including the U-shaped wall is shown in the center of the figure. The results on the top relate to a version of the present methodology that does not include autorecurrent latent dynamics (i.e. where each code is zᵢ₊₁:=Δᵢ), termed EDDICT-Δ. The results on the bottom relate to implementations that make use of the latent dynamics described herein, termed EDDICT (Entropic Desired Dynamics for Intrinsic Control).

As shown in FIG. 5, EDDICT successfully recovers the ground truth coordinates of the point mass position (under the agent's control), but not the target position (randomly set per episode and not under the agent's control). The topological structure of the environment is shown in the latent variables. This can be seen through the correlation between shading (representing the ground truth coordinates) and plot position (representing the latent variable). This is caused by the additive autorecurrent latent dynamics, which encode a notion of code proximity. There is clear discontinuity in the codes determined by EDDICT, showing where the agent is unable to pass through the wall. This shows that the present implementations yield latent state representations that are meaningful. In contrast, the EDDICT-Δ, which does not implement the desired latent dynamics described herein, does not yield latent state representations that correspond to the topology of the environment.

The methodology described herein was also tested using the Atari™ game Montezuma's Revenge, which is known to be a difficult game for testing exploration.

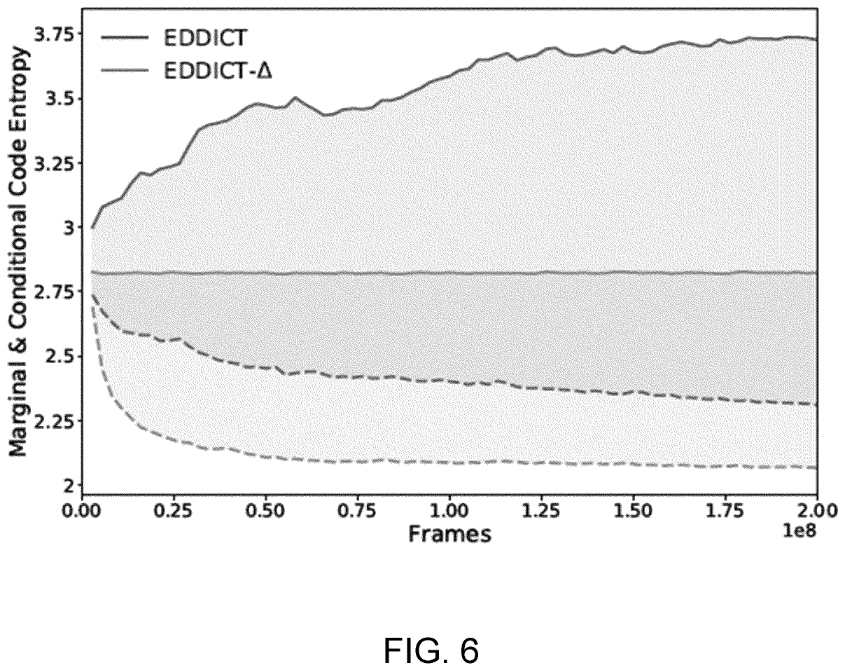

FIG. 6 shows the estimated marginal code entropy H[Zᵢ] (solid) and conditional entropy H[zᵢ|sᵢ₊₁] (dashed) for EDDICT and EDDICT-Δ. It can be seen that EDDICT allows the marginal code entropy to increase over time, whereas EDDICT-Δ shows a fixed marginal code entropy over time. Whilst the conditional entropy (how predictable the code is from the final state) is lower for EDDICT, EDDICT achieves higher mutual information [symbol] ₚ(zᵢi; sᵢ₊₁) (the difference between the marginal code entropy and the conditional entropy). This higher mutual information shows the increased dependence between the latent variables and the final state, meaning that the implementations described herein achieve greater control over the environment that fixed code alternatives.

In addition to the above, EDDICT has been found to outperform other intrinsic control methods with regard to exploration, especially when applied to Montezuma's Revenge, which is known to be one of the hardest exploration games.

In light of the above, unsupervised reinforcement learning may implemented with improved exploration by chaining together latent variables through fixed additive latent dynamics. By implementing unsupervised reinforcement learning before supervised learning (e.g. based on one or more specific tasks), the system may leverage its learned understanding of the environment to make the subsequent training based on tasks more efficient. Notably, the methods described herein result in latent dynamics that accurately represent the dynamics of the environment and indicate greater control of the environment.

The above described methods and systems may be incorporated into a reinforcement learning system that trains an action-selection neural network (and potentially a predictor neural network) through reinforcement learning for use in controlling an agent to perform a reinforcement learning task while interacting with an environment. The methods described above may train the agent based on intrinsic rewards (e.g. rewards that are not received from the environment, such as entropy-based rewards). Subsequent to this, the system may be trained based on extrinsic rewards to perform a particular task.

In particular, at each time step during the training, the reinforcement learning system receives data characterizing the current state of the environment. Data characterizing the state of the environment will be referred to as an observation. In response to the observation, the system selects an action to be performed by the agent and causes the agent to perform the selected action. Once the agent has performed the selected action, the environment transitions into a new state and the system receives a reward. This may be an intrinsic reward or an extrinsic reward, i.e. an external reward as contrasted with the previously described entropy-based reward.

In general, the reward is a numerical value. The reward may indicate whether the agent has accomplished the task, or the progress of the agent towards accomplishing the task. For example, if the task specifies that the agent should navigate through the environment to a goal location, then the reward at each time step may have a positive value once the agent reaches the goal location, and a zero value otherwise. As another example, if the task specifies that the agent should explore the environment, then the reward at a time step may have a positive value if the agent navigates to a previously unexplored location at the time step, and a zero value otherwise.

The reinforcement learning system may use any model-based or model-free reinforcement learning method, for example a policy gradient technique such as an actor-critic (A-C) method, a Trust Region Policy Optimization (TRPO) method, or a Deep Deterministic Policy Gradient (DDPG) method; or a function approximation technique such as a Deep Q-Network (DQN) method.

For example in an actor-critic based implementation action-selection neural network may have a value head to generate a value estimate and a policy head to provide an action selection output. The value estimate may represent a value of the environment being in the current state to successfully performing the task. For example, it may comprise an estimate of the return for the task resulting from the environment being in a current state characterized by the observation.

Generally, an action-selection neural network receives a network input including an observation and generates a network output that defines an action selection policy for selecting an action to be performed by the agent in response to the observation.

In some implementations, the network output defines a likelihood distribution over actions in a set of possible actions. For example, the network output may include a respective numerical likelihood value for each action in the set of possible actions. As another example, the network output may include respective numerical values defining the parameters of a parametric probability distribution (e.g., the mean and standard deviation of a Normal distribution). In this example, the set of possible actions may be a continuous set (e.g., a continuous range of real numbers). In some of these implementations, the system selects the action to be performed by the agent by sampling an action from the set of possible actions based on the likelihood distribution.

In some implementations, the network output identifies an action from the set of possible actions. For example, if the agent is a robotic agent, the network output may identify the torques to be applied to the joints of the agent. In some of these implementations, the system selects the action identified by the network output as the action to be performed by the agent or adds noise to the identified action and selects the noisy action as the action to be performed.

In some implementations, the network input includes both the observation and a given action from the set of possible actions, and the network output is an estimate of a return that will be received by the system if the agent performs the given action in response to the observation. A return refers to a cumulative measure of reward received by the system as the agent interacts with the environment over multiple time steps. For example, a return may refer to a long-term time-discounted reward received by the system. In some of these implementations, the system can select the action that has the highest return as the action to be performed or can apply an epsilon-greedy action selection policy.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment. Intrinsic (unsupervised) training, as discussed herein, can be implemented initially to train the agent to understand its environment. Following this, the agent may be trained for the specific task.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The (extrinsic) rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The (extrinsic) rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The (extrinsic) rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmachemical drug and the agent is a computer system for determining elements of the pharmachemical drug and/or a synthetic pathway for the pharmachemical drug. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources e.g. on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The (extrinsic) rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus a design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

Once trained the system may be used to perform the task for which it was trained, optionally with training continuing during such use. The task may be, e.g., any of the tasks described above. In general the trained system may be used to control the agent to achieve rewards or minimize costs as described above. Merely by way of example, once trained the system may be used to control a robot or vehicle to perform a task such as manipulating, assembling, treating or moving one or more objects; or to control equipment e.g. to minimize energy use; or in healthcare, to suggest medical treatments.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method for controlling an agent while interacting with an environment, wherein the agent is controlled to execute a sequence of actions defining a state-action trajectory for achieving a goal, the goal comprising a sequence of local goals, each local goal being characterized by a corresponding latent variable, wherein each state-action trajectory comprises a set of sub-trajectories and each sub-trajectory is generated according to a corresponding local goal, the method comprising:
for each of a plurality of iterations, wherein each iteration corresponds to one of the sub-trajectories:
determining the latent variable for the corresponding local goal using a predictor neural network configured to predict the latent variable in accordance with predictor parameter values based on a preceding latent variable; and
for each iteration, obtaining the corresponding sub-trajectory by, for each of a plurality of time steps:
obtaining an observation characterizing a current state of the environment;
processing the observation using the action selection policy neural network to generate a policy output, wherein the action selection policy neural network is conditioned on the latent variable and generates the policy output in accordance with policy parameter values of the action selection policy neural network; and
selecting an action to be performed by the agent in response to the observation using the policy output.

2. The method of claim 1 wherein determining the latent variable comprises determining the previous latent variable and adding a perturbation to the previous latent variable to generate the latent variable.

3. The method of claim 2 wherein the perturbation is determined from a perturbation distribution, the perturbation distribution being one of a uniform distribution or a Gaussian distribution.

4. The method of claim 1, wherein the previous latent variable is determined by determining the previous latent variable that is most likely to have conditioned the action-selection neural network to generate a previous sub-trajectory for the previous iteration according to the predictor neural network.

5. The method of claim 4 wherein the previous latent variable is determined based on a last observation from the previous sub-trajectory.

6. The method of claim 5, wherein determining the previous latent variable comprises inputting the last observation from the previous sub-trajectory into the predictor neural network to predict the previous latent variable.

7. The method of claim 1, wherein each latent variable is linearly related to the preceding latent variable.

8. The method of claim 1, wherein the method is initialized by determining a first latent variable based on a first observation characterizing a first state of the environment.

9. The method of claim 1, wherein latent variables over the iterations form a Markov chain.

10. The method of claim 1, further comprising updating one or both of the policy parameter values and the predictor parameter values based at least on one or more of the sub-trajectories.

11. The method of claim 1, further comprising one or both of:
updating the policy parameter values based on a first objective that aims to maximize an entropy of the policy; and
updating the predictor parameter values based on a second objective that aims to minimize a cross-entropy between consecutive latent variables.

12. The method of claim 10, wherein updating the policy parameter values comprises a reinforcement learning update based on a reward rᵢ for each iteration where:
rᵢ×log q_{w}(zᵢ|s_{T,i})
and
zᵢ is the latent variable for the i^{th} iteration,
s_{T,i} is a last observation of T observations for the i^{th} iteration, and
q_{w} is a probability distribution describing a probability of zᵢ given s_{T,i} according to the predictor parameter values w.

13. The method of claim 10, wherein updating the predictor parameter values comprises an update that attempts to minimize a difference between consecutive latent variables.

14. The method of claim 13 wherein a probability distribution q_{w} describing a probability of a latent variable z given an observation s according to predictor parameter values w is q_{w}(z|s)= [symbol] (ƒ_{w}(s), 1) for a function ƒ_{w}(s) where [symbol] (·,·) represents a Gaussian distribution and the update aims to minimize:
∥Δᵢ(ƒ_{w}(s_{(i+1)K})−ƒ_{w}(s_{iK}))∥₂²
where
s_{(i+1)K} is a last observation of K observations for the i^{th} iteration;
s_{iK} is a last observation of K observations for the (i−1)^{th} iteration; and
Δᵢ is a perturbation added an output from the predictor parameter neural network at the i^{th} iteration to determine the i^{th} latent variable.

15. The method of claim 1, wherein the observations relate to a real-world environment and wherein the selected action relates to an action to be performed by a mechanical agent.

16. The method of claim 15 wherein the method controls the agent to perform a task while executing the options, the method further comprising using the predictor neural network and the action selection policy neural network to control the mechanical agent to perform the task while interacting with the real-world environment by obtaining the observations from one or more sensors sensing the real-world environment and using the policy output to select actions to control the mechanical agent to perform the task.

17. (canceled)

18. A system comprising one or more computers and one or more storage devices storing instructions that when executed by the one or more computers cause the one or more computers to perform the operations for controlling an agent while interacting with an environment, wherein the agent is controlled to execute a sequence of actions defining a state-action trajectory for achieving a goal, the goal comprising a sequence of local goals, each local goal being characterized by a corresponding latent variable, wherein each state-action trajectory comprises a set of sub-trajectories and each sub-trajectory is generated according to a corresponding local goal, the operations comprising:
for each of a plurality of iterations, wherein each iteration corresponds to one of the sub-trajectories:
determining the latent variable for the corresponding local goal using a predictor neural network configured to predict the latent variable in accordance with predictor parameter values based on a preceding latent variable; and
for each iteration, obtaining the corresponding sub-trajectory by, for each of a plurality of time steps:
obtaining an observation characterizing a current state of the environment;
processing the observation using the action selection policy neural network to generate a policy output, wherein the action selection policy neural network is conditioned on the latent variable and generates the policy output in accordance with policy parameter values of the action selection policy neural network; and
selecting an action to be performed by the agent in response to the observation using the policy output.

19. One or more non-transitory computer storage media storing instructions that when executed by one or more computers cause the one or more computers to perform the operations for controlling an agent while interacting with an environment, wherein the agent is controlled to execute a sequence of actions defining a state-action trajectory for achieving a goal, the goal comprising a sequence of local goals, each local goal being characterized by a corresponding latent variable, wherein each state-action trajectory comprises a set of sub-trajectories and each sub-trajectory is generated according to a corresponding local goal, the operations comprising:
for each of a plurality of iterations, wherein each iteration corresponds to one of the sub-trajectories:
determining the latent variable for the corresponding local goal using a predictor neural network configured to predict the latent variable in accordance with predictor parameter values based on a preceding latent variable; and
for each iteration, obtaining the corresponding sub-trajectory by, for each of a plurality of time steps:
obtaining an observation characterizing a current state of the environment;
processing the observation using the action selection policy neural network to generate a policy output, wherein the action selection policy neural network is conditioned on the latent variable and generates the policy output in accordance with policy parameter values of the action selection policy neural network; and
selecting an action to be performed by the agent in response to the observation using the policy output.

20.-21. (canceled)

22. The non-transitory computer storage media of claim 19, wherein determining the latent variable comprises determining the previous latent variable and adding a perturbation to the previous latent variable to generate the latent variable.
